(19) United States
(12) Patent Application Publication
(10) Pub. No.: US 2015/0350274 A1
(43) Pub. Date: Dec. 3, 2015

(54) PROGRAM RECOMMENDATIONS FOR GROUP VIEWING

(71) Applicant: AT&T Intellectual Property I, L.P., Atlanta, GA (US)

(72) Inventors: Jesse Chan, Bothell, WA (US); James Gordon Beattie, JR., Bergenfield, NJ (US)

(73) Assignee: AT&T Intellectual Property I, L.P., Atlanta, GA (US)

(21) Appl. No.: 14/291,751

(22) Filed: May 30, 2014

(51) Int. Cl. H04L 29/06; G07C 13/00

(52) U.S. Cl. CPC H04L 65/4092; G07C 13/00; H04L 65/4084

(57) ABSTRACT

A group viewing application includes a host application performed by a host device and a client application performed by a plurality of mobile devices to present program recommendations to mobile device users who have linked with a group maintained by the host application. The host device may be a set top box or smart television programmed with host application software. The host application may perform linking operations to define the group of mobile device users, recommendation operations to identify programs recommended for the group based at least in part on multimedia profile information including content preferences and viewing history information, and election operations to select one of the recommended programs for group viewing.

### BACKGROUND

1. Field of the Disclosure

Disclosed subject matter is in the field of multimedia content services and more specifically, techniques and systems for identifying a program of multimedia content that may be presented to a group of viewers.

2. Description of the Related Art

Selecting the best television program or movie for a group of people becomes increasingly difficult as the size of the group increases. Identifying a single program to present to an ad hoc group is challenging for a number of reasons including divergent interests and preferences among the group members and a lack of information easily accessible to the group members indicating what programs are available. Frequently, however, it is desirable to provide multimedia content to an informally gathered group as a form of background entertainment. Providing a program in this manner may be appropriate for a number of different types of groups including, as examples, a group of extended family members and friends on a holiday visit, an informal party or other social event, a group of travelers assembled at a gate awaiting a departure, people waiting for their vehicles in an auto repair shop, patients awaiting an appointment at the office of a doctor or dentist, and so forth.

### BRIEF DESCRIPTION OF THE DRAWINGS

FIG. 1 illustrates an environment suitable for a group viewing recommendation;

FIG. 2 illustrates elements of a group viewing recommendation operation;

FIG. 3 illustrates elements of a host application;

FIG. 4 illustrates elements of a multimedia profile;

FIG. 5 illustrates elements of a group viewing recommendation operation;

FIG. 6 illustrates a user linking interface of a group viewing recommendation operation;

FIG. 7 illustrates a recommended programs interface of a group viewing recommendation operation;

FIG. 8 illustrates a candidate program interface of a group viewing recommendation operation;

FIG. 9 illustrates an election result interface of a group viewing recommendation operation;

FIG. 10 illustrates a host experience interface of a group viewing recommendation operation; and

FIG. 11 illustrates a client experience interface of a group viewing recommendation operation.

### DESCRIPTION OF EMBODIMENTS

A feature or service for providing multimedia group viewing recommendations includes a host application performed by a host device and a client application performed by a plurality of mobile devices to present program recommendations to mobile device users who have linked with a group maintained by the host application. The host device may be a set top box, a smart television, or another suitable Internet enabled device that includes a processor and a memory device or other form computer readable medium that includes processor-executable program instructions for the host application and the client device is a smart phone, tablet device, laptop computer, or other form of portable, wireless-capable computing device that includes a processor and a memory device or other form computer readable medium that includes processor-executable program instructions for the client application. In still other embodiments, a mobile device that provides the client application for one of the group members may also serve as the host device that provides the host application to the group.

Embodiments of the host application perform linking operations to define a group of mobile device users, recommendation operations to identify programs recommended for the group based in part on any available multimedia profile information including content preferences and viewing history information of at least some of the group members, election operations to select one of the recommended programs for group viewing, and evaluation operations to obtain user evaluations of various aspects of the client application and the group viewing recommendation service generally and make appropriate modifications.

The linking operations performed by the host application may include operations for creating a content viewing group, referred to herein simply as a group, representing a plurality of mobile device users who share a common interest in a group viewing recommendation. The common interest shared by the group members may include, as an example, access to a common display screen visible or easily visible to each of the group members. These embodiments encompass situations in which the group members may view the content on the same display screen at the same time including holiday gathering, parties, and the like. In these embodiments, the host device is closely associated with the display screen and may be implemented in a set top box that controls the display screen or a smart television in which the display screen is included. In other embodiments, the host application may be decoupled from any particular display screen. For example, group members may share a desire to identify a movie for viewing in a theater at a time or date in the future. In these embodiments, the device that functions as the host device to execute the host application may be the mobile device of one of the group members or a web-accessible server.

The linking operations performed by the host application may include displaying or otherwise publishing a linking code corresponding to the group being created. Mobile device users who view or otherwise obtain the linking code may then join the group by opening the client application, after first downloading the application if the application is not previously installed on the mobile device, and entering the linking code. In at least some embodiments, the client application supports individual user accounts and is configured to maintain profile information and other user-specific metadata for each recognized user account, but the client application also supports anonymous execution of at least some functionality including linking functionality.

Anonymous linking support beneficially facilitates greater participation by enabling mobile device users simply to open the client application and begin using it to link to a group and vote for recommended programs. If a mobile device user does not have the client application installed on the user's mobile device, the user can simply download the application from a file server and start using it to link to a group without having to establish an account or provide any user profile information. In addition, mobile device users who have a client application user account, including a user ID, password, and profile information, may nevertheless elect to link to a group anonymously, either by using the client application without logging into it, or by logging into the client application and selecting an anonymous linking option within the client application.

In some embodiments, the client application may offer registered users, i.e., users who have a user account and are logged into the account, varying degrees of anonymity with respect to profile information. For example, profile information may include viewing history information and content preferences information and the client application may permit the registered user to expose the content preferences information to the host application but not the viewing history information or vice versa. Similarly, the client application may record a registered user's votes and maintain voting history information, either as a part of the profile information or separately from the profile information, and the registered user may be permitted to allow or prevent recording of the user's votes within the current group and to allow or prevent the host application from accessing a user's voting history for use in identifying recommend programs. Additionally, the client application may support varying degrees of anonymity by permitting more granular control of portions of profile information according to any suitable profile parameter. Viewing history information, for example, may include time and date information and the client application may permit the user to selectively grant host application access to recent viewing history, weekend viewing history, daytime viewing history, and so forth.

Anonymous linking facilitates low-barrier, albeit low-influence, participation in the group recommendation process for users who may wish to cast a vote for a program but who lack the time or desire to provide the profile information needed to influence the host application's selection of candidate programming. Registration support, on the other hand, offers users who are willing to sacrifice some time, effort, and anonymity, the opportunity to influence the selection of candidate programming.

Linking a mobile device to a group may occur upon detecting a wirelessly transmitted linking message generated by the client application. The client application may generate the linking message when a mobile device user enters the correct linking code associated with the group. The linking message may include the linking code and an identifier of the user or the mobile device. If a registered user is linking, the user identifier may include the user's client application user ID. If a mobile device user is linking anonymously, the client identifier may include identifying data associated with the mobile device. In some embodiments the host application and the client application communicate via a wireless local area network interface, for example, an IEEE 802.11 (WiFi) interface or via a personal local area network interface, for example, a Bluetooth or Zigbee interface.

The host application may employ both open-ended linking and closed-window linking. In open-ended linking, the host application may accept linking messages that include the correct linking code at any point in the life cycle of the group. The host application may update the group to include the new member and obtain any profile information accompanying the new member. All subsequent activity of the host application may then be based on a group membership that includes the new member. In closed-window linking, the host application may accept appropriately configured linking responses only during a specified window of time, referred to herein as the linking window. In closed-window linking embodiments, the linking window may close after a predefined duration, in response to an explicit request from a group member to close linking, in response to determining that a threshold percentage of mobile device users eligible to link have linked, or in accordance with any other suitable criteria.

In some embodiments, the host application displays a list or other indication of the currently linked members of the group during the linking window in a closed-window linking embodiment or until a recommendation is provided by the host application in an open-ended linking embodiment. Embodiments of the host application may also permit the client application of a linked member to display the group member list temporarily at any time. The list may be displayed on the display device of the host device, on the display device of the mobile devices, or both. The operations may also include operations for un-linking all currently linked members in response to a close group request or a new group request from a client application.

In some embodiments, linked members of a group may invite guests or other mobile device users to join a group. For example, if the group of mobile device users assembled at a particular location is expecting at least one more person to arrive, the mobile devices users who have arrived may launch the host application to obtain a linking code and begin the linking process. One or more of the linked members of the group may then communicate by text, email, or voice call the group's linking code to the person who has not arrived. The absent mobile device user may then link to the group, either anonymously or as a registered user, from a remote location.

Recommendation operations performed by at least some embodiments of the host application include accessing any multimedia profile made available to the host application by of one or more client devices for use in evaluating or identifying recommended programs. As indicated previously, each client application of a registered user may include or maintain a multimedia profile. A multimedia profile may include a voting history of the client application as well as viewing habit information associated with the mobile device user. The viewing habit information may include, as examples, viewing history information indicating the program viewing history of the mobile device user, program preference information indicating program preferences specified by the user, multimedia search history information, and program ratings authored by the user. The multimedia profile may further include demographic information including age, gender, residence, race, citizenship, marital status, primary language, religious affiliation, ethnicity, and any other information that may correlate with program preferences.

In at least one embodiment, all or some multimedia profile information associated with a registered user of the client application may be imported from one or more external entities and aggregated in profile information stored on or directly accessible to the client application. External entities from which multimedia profile information may be accessed or retrieved include multimedia content vendors such as Netflix, Amazon, iTunes, Hulu, and similar services, as well as the registered user's multimedia service provider (e.g., IPTV, cable, or satellite provider). Multimedia profile information may also be imported from one or more social networks including, as non-limiting examples, Twitter, Facebook, and the like, of which the client application user is a member. Aggregating information from a multimedia viewing application may include selecting a supported content vendor or social network from a user interface listing the supported vendors and providing authentication information, e.g., user ID and password information for the selected service. In some embodiments, a registered user of the client application can log into the client application at any time and update the user's profile information independent of linking to a content viewing group.

The recommendation operations performed by the host application may further include generating a group viewing recommendation, including a plurality of recommended programs, based on a combination of any multimedia profile information provided or made available to the host application and any available program information retrieved from one or more multimedia service providers and content vendors. The group viewing recommendation may be displayed or otherwise presented to the linked members of the group by the host application.

The election operations performed by the host application may include receiving or otherwise detecting votes for one or more of the recommended programs wirelessly transmitted by the client applications of the group members during an election period and determining an elected program based on the votes. In at least one embodiment, the host application conducts elections by displaying or otherwise presenting the plurality of recommend programs one at a time to the group. During this type of an election, each group member may cast a vote for against or decline to cast a vote for any or all of the recommended programs. Each vote may indicate a degree of approval for the applicable program.

Elections that employ a binary voting format permit a group member to cast either of two vote types for a particular program or to cast no vote for the particular program. For example, a binary voting election embodiment may permit linked members to cast a FOR or AGAINST vote, a LIKE and DISLIKE vote, and so forth. In these embodiments, the absence of an explicit vote for or against a program may be treated as an indication of neutrality or no preference. For example, a group member who may be indifferent with respect to four of five recommended programs, but has a strong preference against the fifth program might indicate no vote for the four programs and vote AGAINST the fifth program. In other embodiments, the domain of vote types may include more than two types of affirmative votes, e.g., LOVE, LIKE, NEUTRAL, DISLIKE, and HATE.

Other embodiments may conduct elections differently. For example, in some embodiments, the entire list of recommended programs may be presented simultaneously on a single ballot and each group member may rank or otherwise provide a relative rating for all or some of the recommended programs. In a ballot voting embodiment, the entire list of recommended programs may be presented simultaneously and a vote indicates which one or more of the plurality of recommended programs the user has selected. For example, the ballot of recommended program may include five recommended programs of which each voter may vote for two titles or the ballot may include two titles of which the user may vote for one.

The group viewing recommendation operations may further include determining an elected program based on the votes received and displaying an election result indicative of the votes received for each of the recommended programs. In some embodiments, determining an elected program may include determining whether any of the recommended programs qualifies as a winner according to predetermined criteria. In a binary voting embodiment, for example, criteria may specify that a winner is a program that receives the greatest percentage of LIKE votes or a program that receives a normalized percentage of LIKE votes exceeding 50.

The group viewing recommendation operations may determine that there is no winner and perform a series of one or more runoff elections to determine the elected program. In at least one embodiment, performing a runoff election includes identifying a subset of the recommended programs as the runoff election candidate, presenting each of the runoff candidates to the group, recording votes corresponding to each runoff candidates, and then either declaring an elected program as the winner of the election or performing an additional runoff election. In at least one embodiment, identifying the runoff candidates for inclusion in a runoff election in a binary voting electing may include identifying the smallest number of recommended programs that collectively received a normalized percentage exceeding a specified threshold.

The evaluation operations performed by the host application may include recording host experience data summarizing characteristics of the group viewing recommendation application and methods. Client experience data summarizing group member indications of favorability regarding aspects of the group viewing recommendation method may be recorded. The group viewing recommendation application may be modified based on an analysis of the experience data. For example, a modification of the host application or client application may be made based on a degree of correlation between at least one element of the host experience data and at least one element of the client experience data.

Embodiments of disclosed subject matter also encompass the memory device or other computer readable medium that includes the host application as well as the method or process, i.e., the sequence of group viewing recommendation operations that the host device processor performs in response to executing the host application.

Still other embodiments of disclosed subject matter are directed to the mobile device that includes the client application or is otherwise suitable for communicating with the host device to link to a group and participate in a group viewing election to identify a program most preferred for viewing by a group of mobile devices users as a whole. In at least one embodiment, the mobile device includes a processor, a wireless transceiver that supports a wireless communication interface, and a memory device or another type of computer readable storage that includes processor executable instructions for a group viewing recommendation client application. Execution of the client application by the processor causes the processor to perform client operations including linking to a group by sending a message including a linking code to the host application and voting, during an election period, for one or more of a plurality of programs recommended by the host application. The mobile device may comprise, as non-limiting examples, a smart phone, a tablet device, a laptop computer, or any other mobile computing device.

The mobile device may include a multimedia profile including voting history information and viewing habit information that includes program viewing history information, content search history information, program preferences specified by the users, and program rating authored by the user. The multimedia profile may also include demographic information applicable to the mobile device user.

The client application may permit the host application to access all, some, or none of any profile information stored on the mobile device. In at least one embodiment, the client application supports anonymous linking, which enables the mobile device user to link to a group and vote without exposing any profile inflation to the host application. The client application may also enable a registered user to log in to the client application and make all or some of the profile information accessible to the host application. As indicated previously, a mobile device user who provides profile information has greater influence over the selection of recommended content by the host application while an anonymous user more privacy. In some embodiments, the client application enables the mobile device user to indicate to the host application whether to record the user's votes, whether to consider the user's previous votes when recommending content, and whether to permit host application access to any or all of the profile information.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

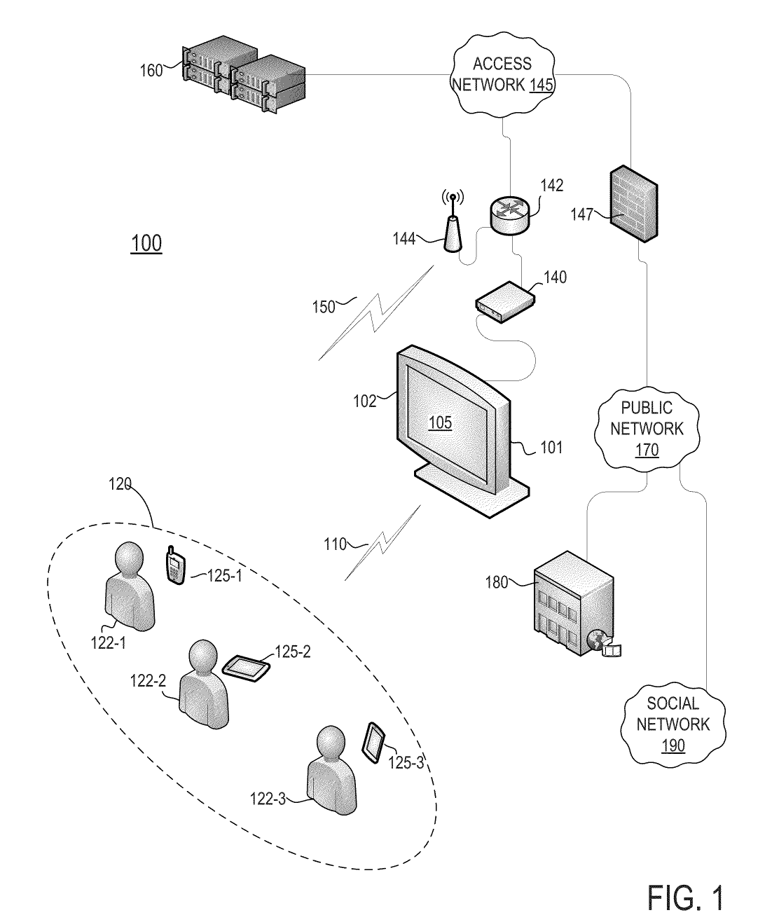

FIG. 1 illustrates a group viewing system 100 suitable for providing a group viewing recommendation feature, service, or application. The group viewing system 100 illustrated in FIG. 1 includes a host device 101 and its corresponding display device 105 in wireless communication with a group 120 of mobile device users 122 over a wireless communication medium 110. Group 120 as illustrated in FIG. 1 includes a plurality of mobile device users 122, each of which is associated with a corresponding mobile device 125.

The host device 101 illustrated in FIG. 1 includes or controls display screen 105, which is suitable for displaying or playing multimedia content. Host device 101 may be any of a variety of network-aware devices capable of rendering or playing multimedia content on display screen 105. The host device 101 illustrated in FIG. 1 comprises a smart television 102. For purposes of this disclosure, a smart television is a television that includes resources for wirelessly communicating with other network aware devices over wireless communication medium 110. The wireless communication medium 110 may comprise a wireless local area network such as an IEEE 802.11 (Wi-Fi) network, a wireless personal area network such as a Bluetooth or Zigbee network, or another suitable wireless network.

FIG. 1 illustrates host device 101 communicatively coupled to multimedia service provider 160 via a set top box 140, residential gateway 142, and an access network 145. The host device 101 illustrated in FIG. 1 is also shown communicatively coupled to a content vendor 180 and a social network 190 via access network 145 through firewall 147 and public network 170, which may include the Internet. In addition, mobile devices 125 may be communicatively coupled to content vendor 180 and social network 190 via wireless network 150, gateway 142, access network 145, and public network 170 through firewall 147.

In some embodiments, multimedia service provider 160 represents a multimedia delivery platform providing live and pre-recorded local and national television, video on demand, and pay-per-view programming over a suitable access medium including, as examples, a co-axial cable access medium, a satellite/wireless medium, and an IP television medium. Multimedia service provider 160 may encompass features similar to features provided by Comcast, Time Warner cable, Uverse, FiOS, DirectTV, Dish Network, and the like. Content vendors 180 may provide free or paid access to pre-recorded content for streaming or downloaded playback via proprietary or standardized media players. Content vendors 180 may include features similar to features provided by Amazon, Netflix, Hulu, and other sources of pre-recorded media for online acquisition, delivery, and playback.

Host device 101 may receive available program information representing the universe of programming that host device 101 may recommend to group 120. The available program information received by host device 101 may include, as non-limiting examples, electronic programming guide data from multimedia service provider 160 and a catalogue of available titles from convent vendor 180.

Host device 101 may also access multimedia profile information stored on the mobile devices 125 of one or more group members 122. The multimedia profile information may include information indicative of multimedia preferences and viewing history of the group member 122. The multimedia profile information on a mobile device 125 may include profile information imported from an external site such as any content vendor 180, social network 190, or multimedia delivery network 160 with which the group member has an account.

Although FIG. 1 illustrates smart television 102 functioning as host device 101, host device 101 may be implemented in set-top box 140 or another customer premises device in other embodiments, especially embodiment in which the smart television 102 of FIG. 1 is replaced with a conventional television (not depicted) that is incapable of wireless communication with other CPE devices over a wireless communication medium 110.

FIG. 1 illustrates a group 120 including a plurality mobile device users 122, each with a corresponding mobile device 125, in proximity to host device 101 or display screen 105. As illustrated in FIG. 1, group 120 includes three mobile device users 122-1, 122-2, and 122-3. One of skill will appreciate, however, that group 120 may include a different number of mobile devices users 122. In at least one embodiment, the group 120 of users 122 are located within a single room or within close proximity to display screen 105 such that each user may be viewing content playing on display screen 105. In some embodiments, there may be other mobile device users in proximity to display screen 105 that elect not to participate in the group viewing recommendation process. In these embodiments, group 120 may represent the mobile devices users 122 who have linked with host application 101 for a specific group. The mobile device users 122 who have linked with the group 120 may be referred to herein as linked members 122.

Although the group 120 illustrated in FIG. 1 depicts a close proximity group in which the mobile device users 122 are in close proximity to display screen 105 and/or host device 101, group 120 may, in other embodiments, include mobile device users 122 who are not necessarily located in proximity to a common display screen or host device. For example, a group 120 of mobile devices located in different locations may be interested in meeting at a theater to watch a movie at a specified time and location. To support group recommendations for geographically dispersed groups 122, host device 101 may be a network server (not depicted) or even one of the mobile devices 125.

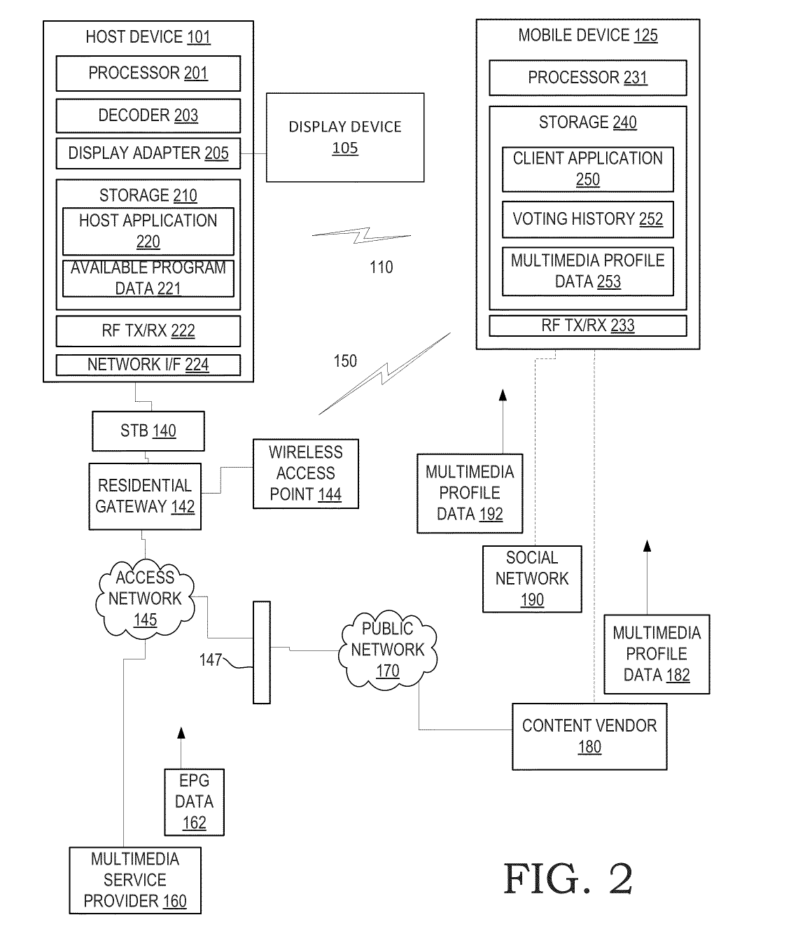

Referring now to FIG. 2, host device 101 is depicted including a processor 201, a decoder 203, which may include an audio decoder and a video decoder for processing multimedia content received from multimedia service provider 160 via network interface 224, a display adapter 205, and storage 210. Storage 210 represents a memory device or another form of computer readable storage that includes instructions executable by processor 201. In the host device 101 illustrated in FIG. 2, storage 210 includes a host application 220 and available program data 221. The host device 101 illustrated in FIG. 2 further includes a radio frequency transceiver 222 and a network interface 224. The radio frequency transceiver 222 enables host device 101 to communicate wirelessly over various wireless communication media including wireless local area network such as Wi-Fi and wireless personal area networks such as Bluetooth and Zigbee.

The host device 101 illustrated in FIG. 2 is communicatively couple to external networks including access network 145 and public network 170 by way of set top box 140 and residential gateway 142. In other embodiments in which host device 101 is integrated within set top box 140, host device 101 is communicatively coupled to external networks through residential gateway 142.

The mobile device 125 illustrated in FIG. 2 includes a processor 231 and computer readable storage 240. Storage 240, similar to storage 210, may include one or more memory devices or one or more other forms of computer readable storage capable of storing computer executable instructions and data. The storage 240 illustrated in FIG. 2 includes a client application 250 and data including voting history data 252 and multimedia profile data 253. In addition, mobile device 125 includes a radio frequency transceiver 233 suitable for supporting wireless communication between mobile device 125 and other wireless network elements including host device 101 over wireless communication medium 110. Like radio frequency transceiver 222 of host device 101, radio frequency transceiver 233 may support Wi-Fi communication, Zigbee communication, or wireless communication over another suitable wireless local area network or wireless personal area network medium.

Multimedia profile data 253 of the mobile device 125 as illustrated in FIG. 2 may include an aggregation of multimedia profile information 182 from content vendor 180, multimedia profile information 192 from social network 190, profile information from multimedia service provider 160 and any profile information locally generated by client application 250 multimedia profile 253 from content vendor 180. In at least one embodiment, host application 220 uses EPG data 162 and accesses multimedia profile data 182 stored in mobile devices 125 to determine recommended programs. Although group viewing recommendation system 100 as illustrated in FIG. 2 includes external sources of available program data and multimedia profile information, other embodiments may determine available program information and multimedia profile information locally, from information stored on host device 101 in storage 210 or on mobile device 125 in storage 240.

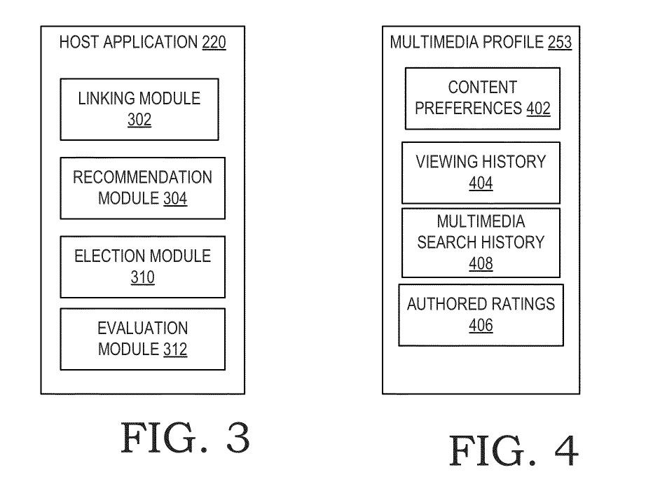

FIG. 3 illustrates host application 220 including a linking module 302, a recommendation module 304, an election module 310, and an evaluation module 312. In some embodiments, linking module 302 is responsible for identifying requests to establish or link to a group, creating the group, and for maintaining information indicative of the mobile devices users currently linked to the group. Linking module 302 may begin to execute whenever host application 220 is launched or in response to a client application request for a group viewing recommendation by presenting a sequence of user interfaces on display screen 105 of FIG. 1 and FIG. 2. Linking module 302 may invite eligible mobile device users to link to a group associated with an upcoming program election. An invitation to link to a group may include a message displayed on a display screen 105 viewable to a plurality of mobile device users 122 in a proximity based group. In other embodiments, including embodiments suitable for a group comprising geographically dispersed mobile devices users, an invitation to link to a group may include a message sent to a mobile device 125 expressly requesting the mobile device user 122 to link to the group and indicating a corresponding group ID. Linking module 302 may also detect requests from the mobile device users in response to the user linking prompting.

Linking module 302 may record information identifying each of mobile device user 122 that responds to or transmits a communication to link to a group that is forming. For example, linking module 302 may initiate and display an interface inviting mobile device users to join a group at the beginning of a social event or other event. In this embodiment, the linking module 302 may maintain the linking process for a predetermined duration. In other embodiments, linking module 302 may provide an open-ended linking process in which the mobile device users associated with a particular group are dynamic and open for modification. These types of applications may be appropriate for publicly viewable display screens including, as examples, displays screens located in airport terminals, hotel lobbies, bars and restaurants, public buildings, and so forth.

In at least one embodiment, recommendation module 304 is responsible for determining a list of recommended programs based on the programming available to the host device and any profile information 304 that may be stored on mobile devices 125 of group members 122 and made available to host application 220 by client application 250. Recommendation module 304 may begin to execute after linking module 302 closes a linking period or while the linking period remains open.

In some embodiments, a mobile device user 122 may opt out of host application access to its multimedia profile 253. As discussed previously host application 220 and client application 250 may a mobile device user 122 to link to a group anonymously by, for example, not logging into the client application 250 with a user ID and a password, and thereby not exposing the mobile device users multimedia profile 253 or voting history 252 to the host application. In embodiments of group viewing recommendation system 100 that permit mobile device users 122 to opt out of providing profile or history data, host application 220 may determine recommendations based on the multimedia profiles and voting histories of the mobile device users who elect not to opt out of this information.

In the event that every linked member 122 of a group 120 either opts out of providing profile information or had no profile information associated with the client application, such as when a mobile device user 122 first downloads or otherwise installs client application 125 on mobile device, host application 220 may identify recommended content randomly or according to some other predefined method that does not require profile information. The host application may, in this situation, prompt the group or a group member to identify a genre or other category or characteristic that the host application may use to filter the available content.

The multimedia profile 253 illustrated in FIG. 4 includes content preferences 402, viewing history information 404, multimedia search history information 408, and authored ratings information 406. In some embodiments, content preferences 402 include preferences specified by the user for various multimedia content parameters including, as non-limiting examples, genre preferences, actors preferences, time period preferences, director preferences, subject matter preferences, and so forth.

In at least one embodiment, viewing history information 404 includes information indicating the mobile device user's prior multimedia content viewing activity. Viewing history 404 may be supplemented with viewing history information provided by external sources including multimedia service provider 160 and content vendor 180. For example, a mobile device user 122 may have a subscription or user account with content vendor 180 enabling the mobile device user 122 to access or otherwise view multimedia content with a conventional web browser or with a dedicated media viewing interface provided by the content vendor. Regardless of the specific implementation of the service, content vendor 180 may maintain data indicating the content acquired or otherwise accessed by mobile device user 122. Similarly, multimedia service provider 160 may maintain viewing history information for its subscribers. The viewing history information for multimedia service provider 160 may be more difficult to associate with an individual mobile device user because, in a conventional multimedia delivery context, the set-top box or smart television receiving content from service provider 160 may not be able to or does not identify the individual user of the service. In some embodiments, multimedia service provider 160 may permit or require the device user 122 to provide identification information and, in these embodiments, viewing history information may be attributed to the identified device user. Other embodiments may employ more, fewer, or different sources of information for multimedia profile 182.

The authored ratings 406 of multimedia profile 182 may include blog postings or other text evaluating multimedia content either qualitatively or numerically. In some embodiments, authored ratings information 406 would include, in addition to the rating itself, and identification of the corresponding program. The multimedia search history information 408 may include information indicating items of content or categories of content searched by a mobile device user 122 one any suitable search engine including search engines provided by content vendors 180. Search history information 408 may capture information not captured in history pertaining only to content that is actually viewed or acquired by a user.

In some embodiments, the host application recommendation module 304 of FIG. 3 may access or otherwise obtain, as part of the group viewing recommendation process, any one or more of the content preferences 402, viewing history 404, multimedia search history information 408, and authored ratings 406 stored in the multimedia profile 253 of one or more mobile device users 122. Recommendation module 304 may employ any suitable algorithm or rules rules-based process for selecting recommended programs based upon multimedia profile information 182 from at least some of the mobile device users for available programming. For example, recommendation module 304 may rely primarily on content preferences 402 for identifying an initial set of recommended programs and may filter or modify the list based upon viewing history information 404. If, as an example, a program recommended based on content preferences 402 has been recently viewed by one or more of the mobile device users, the recommendation module 304 may filter the list of recommended programs. In at least one embodiment, content preferences 402 may be stored within the multimedia profile 253 in a standardized format and the client application 250 may process viewing history information and content preference information received from an external content vendor 180 accordingly.

The specific recommendation module algorithm employed to determine a recommended program based on multimedia profile information is an implementation detail beyond the scope of the present disclosure, which encompasses any suitable evaluation algorithm capable of utilizing at least some of the multimedia profile information 253 illustrated in FIG. 4.

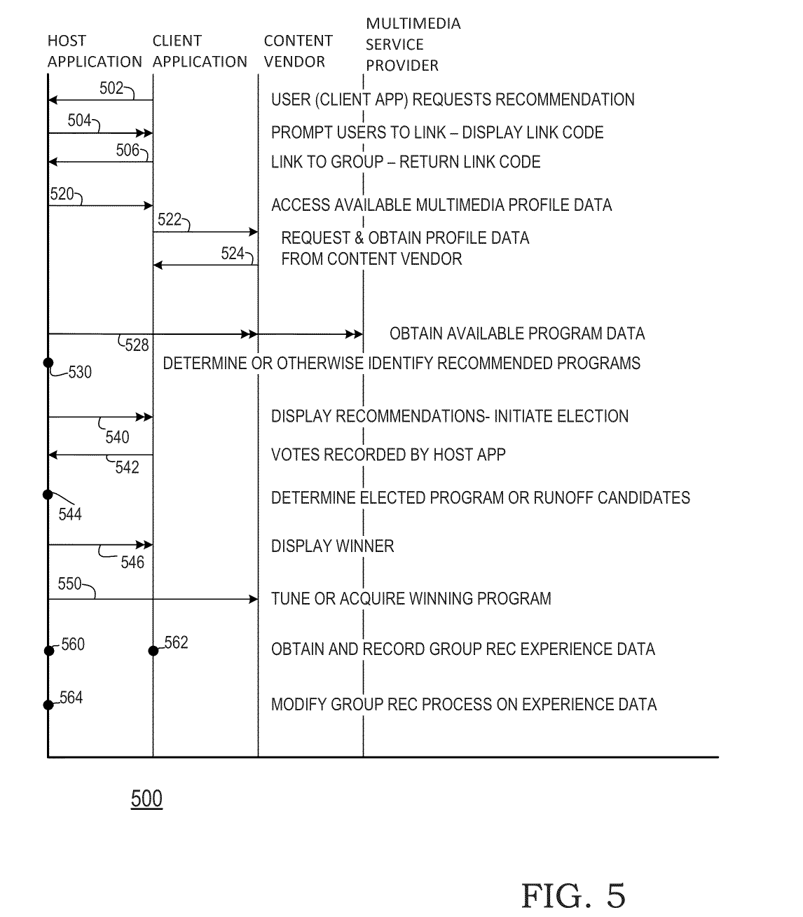

Turning now to FIG. 5, elements of a group viewing recommendation operation 500 are illustrated. The group viewing recommendation operation 500 illustrated in FIG. 5 includes operations performed by host device 101 executing host application 220 and operations performed by mobile device 125 executing client application 250. As illustrated in FIG. 5, operation 500 includes client application 250 transmitting a request for a content recommendation to host application 220 at operation 502. In some embodiments, operation 502 occurs when a mobile device user 125 opens or otherwise starts client application 250. In other embodiments, operation 502 may occur when a user makes an explicit request for a recommendation from within the application. In this embodiment, client application 250 may include a menu item or selection feature on one or more user interfaces for initiating a recommendation request. The recommendation request communicated between client application 250 and host application 220 may occur over wireless communication medium 110 as discussed previously. In still other embodiments, operation 502 is omitted and host application 220 initiates the creation of a new group at operation 504.

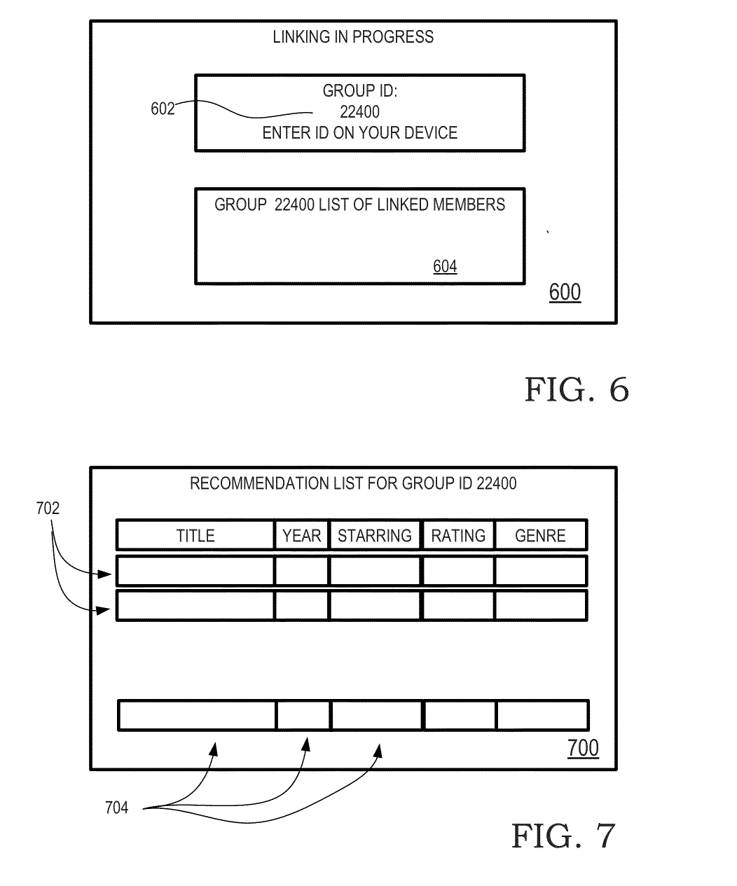

Upon receiving a content recommendation request from a client device, host application 220 may prompt (operation 504) the mobile devices users who have the client application installed to link to the group and vote in a group viewing recommendation election that will occur soon. Host application 220 performs operation 504, in one embodiment, by generating a user linking interface 600, illustrated in FIG. 6, and displaying user linking interface 600 on display screen 105. In at least one embodiment, the host application 220 generates a linking code or group identification and displays the linking code 602 in the user linking interface 600 to prompt mobile device users 122 within sight of the display screen 105 to become a member of or link to the group by entering the linking code in the client application. If a mobile device user 122 wishes to link to the group, the user may open client application 250 and send a response (operation 506) to host application 220 and include in the response the group identification or linking code indicated by the host application.

The client application 250 is configured to send a linking code entered by the user to the host application 220. In this embodiment, all of the mobile device users 122 in group 120 may easily link to a group and without requiring a separate username and password authentication sequence for each mobile device user. In the user linking interface 600 illustrated in FIG. 6, host application 220 maintains and displays a list 604 of mobile device users linked to the group. as mobile device users linked to vote in the group. In some embodiments, host application 220 holds a linking window open for a specified or predetermined duration after which the user linking is closed. In other embodiments, user linking may be an ongoing process in which group members can change dynamically, for example, as mobile device users enter and exit a room where the host application and display screen are located.

In some embodiments, the operation 506 also indicates whether the user associated with the mobile device 125 wishes to make multimedia metadata available to host application 220. For example, if a client application 250 links to a group anonymously, operation 506 may indicate that there is no corresponding profile information associated with the mobile device user and the host application 220 may record that the mobile device user is linked to the group anonymously. The multimedia profile 253, as previously described, may indicate content acquisition and viewing transactions and history of the mobile device user. Voting history information 252 may include information indicating the mobile device user's votes for content using client application 250 on previous occasions. Operation 506 may, in these embodiments, include an indication of whether the mobile device user makes voting history information 252, multimedia profile information 182, or both available to host application 220.

Host application 220, processes linking responses from mobile device users and maintains a record of the list of linked voters. Each instance of operation 506 may include an indication of the corresponding mobile device. The information identifying the mobile device may include a user-friendly identifier, perhaps supplied by the mobile device user, as well as a globally unique identifier of the mobile device, e.g., a media access control address, a subscriber identity module (SIM) card number, or another globally unique identifier. The linking process continues for a predetermined interval in some embodiments and includes reiterations operations 504 and 506.

As illustrated in FIG. 5, host application 220 attempts to access (operation 520) multimedia profile data 253 on mobile device 125. Client application 250 may deny access attempt 520 if the client application 250 is executing anonymously or if the mobile device user has logged in, but indicated a preference not to share profile information.

The attempt to access multimedia profile data at operation 520 may cause client application 250 to import multimedia profile data from an external source such as the content vendor 180 of FIG. 1. As indicated previously, the multimedia profile information 253 may include profile information imported from content vendors 180, social network 190, and multimedia service providers 160 and, in some embodiments, client application 250 may update profile information provided by any external sources in response to detecting host application 220 attempting to access the profile information.

FIG. 5 illustrates client application 250 requesting (operation 522) and obtaining (operation 524) multimedia profile data from a content vendor, social network, multimedia service provider, or another appropriate provider of multimedia media profile information. Although FIG. 5 illustrates operation 522 and 524 occurring following operation 520, client application 250 may retrieve externally maintained profile information at any time, independent of whether the mobile device user is currently linked to a group. For example, the mobile device user may log into client application 250 in a standalone mode, when no group is being formed and no communication with host application 220 is occurring, for purposes of retrieving profile information from external sources.

The client application 250 may support profile information provided by a specific set of approved partners and, in these embodiments, the mobile device user may indicate a specific source of profile information by selecting the external source from a drop down list. The external application may protect the profile information from public access via a user account and password and the mobile device user may store any user accounts and passwords internally. The client application 250 may thereafter, from time to time, login to the mobile device user's account with the external source and retrieve the most recent profile information associated with the mobile device user.

The operations 500 illustrated in FIG. 5 further includes obtaining available program data (operation 528). In at least one embodiment, host application 220 requests available program data from one or more content vendors 180, multimedia service provider 160, or both. As described above with respect to FIG. 2, host application 220 may be in communication with multimedia service provider 160 through STB 140 and an access network 145 provided by the service provider. In these embodiments, the multimedia service provider 160 may provide electronic programming guide data 162 or some other suitable form of available programming information indicating the channels and titles of live television programming in the near future. In addition, available programming information may include information indicating available pre-recorded content including video on demand content from a multimedia service provider 160. The available programming information may still further include a listing of content available from content vendor 180. In some embodiments, a content vendor 180 may make its programs available to an application host application 224 to include the content of vendors library of programs in the election process.

The operations 500 illustrated in FIG. 5 include determining or otherwise identifying (operation 530) recommended programs. The host application 220 uses any profile data obtained from the mobile device users linked in the current group together with available program information retrieved or otherwise acquired from multimedia service provider 116 and content vendor 180 along with any program metadata describing the available content, together with a content recommendation algorithm or a set of content recommendation tables to identify or more recommended programs. In some embodiments, host application 220 generates a plurality of recommended programs as candidates for a vote by the linked members of the group. The number of recommended programs generated by host application 220 is an implementation detail but may be in the range of approximately three programs to seven programs. Other embodiments may generate more or fewer group viewing recommendations.

The content selection algorithm or the content selection rules used by host application 220 may include any algorithm or rule set useful for identifying programs satisfying profile criteria. As suggested previously, any multimedia profile information provided by the mobile device users may influence the identification of programs and certain aspects of the profile may be emphasized to simplify the algorithm. If the group members provide little or no profile information to the host application, the host application may use a default profile for the group that assumes, for example, an audience of diverse ages and interests.

Operations 500 illustrated in FIG. 5 include displaying (operation 540) the recommendations generated by host application 220. In at least one embodiment, displaying the recommendations may include displaying a recommended programs interface 700 depicted in FIG. 7. User interface 700 identifies the list of recommended programs in a table format that includes a row 702 for each recommended program and a plurality of columns 704 describing or indicating characteristics of the applicable program. The recommended programs interface 700 illustrated in FIG. 7, for example, includes a column 704 for the title, year of release, primary stars, rating, and genre of the applicable program.

The rating column may be a parental advisory rating from an organization such as the Motion Pictures of America Association (MPAA). In other embodiments, the rating may be the rating of a critic or other source and may be indicated by the number of stars or other similar representation of a grade or score. The genre may indicate a category of the film such as comedy, war, drama, science-fiction. Although FIG. 7 illustrates a recommended programs interface 700 including a specific number and categories of columns, other embodiments of recommended programs interface 700 may include more, fewer, or different columns than the recommended programs interface 700 illustrated in FIG. 7.

For embodiments employed in close proximity situations, the display of the recommended programs may include displaying the recommended programs on display screen 105 of FIG. 1. When executed in a dispersed group situation, displaying the recommendations may include sending the recommendations to the client applications of the linked members of the group.

After host application 220 has identified and display recommended programs, some embodiments of host application 220 begin a voting or election process to determine which program to play for the group. In some embodiments, elections proceed on a program by program basis where the linked members of the group may cast a vote for each program. In other embodiments, the election may employ a ballot type of format in which all of the titles are presented simultaneously and the user selects one or more of the candidates. For the sake of simplicity and brevity, the embodiments described herein emphasize the program-by-program format. In other embodiments, however, other election formats may be employed.

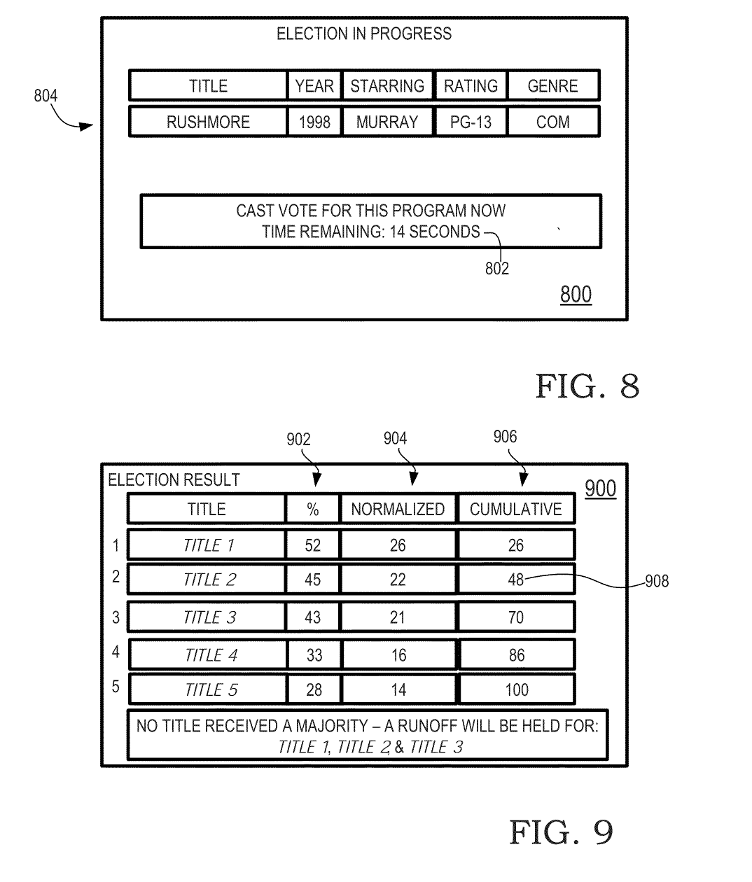

The group viewing recommendation operations 500 illustrated in FIG. 5 include host application recording (operation 542) votes received from client applications 250. Referring to FIG. 8, a candidate program interface 800 suitable for presenting each recommended program to the group may include all or some of the same information that was provided in recommended programs interface 700. Candidate program interface 800 displays information for a single recommended program and may include instructions or prompting and, in the embodiment depicted in FIG. 8, candidate program interface 800 indicates the time remaining 802 for voting on the applicable program 804, which is displayed within candidate program interface 800 as a single row of information. During the time candidate program interface 800 indicates recommended program 804, linked members may indicate a preference for the applicable program by casting a vote.

In at least one embodiment, a vote indicates one of a small number of possible votes. In a binary voting format, for example, linked members may vote FOR the program, AGAINST the program, or cast no vote for the program to indicate neutrality or the lack of a strong preference with respect to the particular program. The labeling of the votes may vary among different embodiments. For example, users may be asked whether they LIKE or DON′T LIKE program 804 in another embodiment of the binary voting format. Other formats may recognize more refined preference indications for each individual provide. For example, some embodiments may permit the user to indicate a range of five preferences from HATE, DISLIKE, DON′T CARE or NEUTRAL, LIKE, and LOVE or analogous preference indications.

Voting associated with the candidate program interface 800 illustrated in FIG. 8 continues until host application 220 has presented each of the recommended programs, i.e., each of the candidates, displayed in recommended programs interface 700 of FIG. 7 in its own candidate program interface 800, allowing a specified window of time for each candidate to be voted upon. In a binary voting format in which users are permitted only to vote FOR a program AGAINST the program, or indicate no preference by abstaining, a relatively short period of time is sufficient to allow each linked member to vote. Embodiments of voting formats permitting more voting options may give linked members more time to cast votes.

The order in which candidates are presented may be controlled by host application 220 in accordance with any one or more rules. For example, host application 220 may present the recommended program exhibiting the highest recommendation score or relevance first. Alternatively, other embodiments may presented the recommendations randomly to prevent or minimize any systematic advantage that may come from possessing a particular slot in the presentation order. Still other embodiments may choose the presentation order differently.

Votes of a linked member may be recorded, for example, in storage 240 of the mobile device 125 associated with the linked member or in networked storage or cloud storage (not depicted) associated with the mobile device or the linked member. Similarly, a group's votes may be recorded in storage 210 of host device 101 or in cloud storage associated with host device 101 or host application 220. In some embodiments, votes may be locally recorded temporarily, until, for example, the vote data is uploaded to cloud storage. In some embodiments, a mobile device user may indicate, as part of the linking process, whether the user wishes to record the votes the user casts in a current session of the group viewing recommendation process for use during subsequent sessions. A mobile device user's prior voting history while using the client application 250 may be used to filter or otherwise influence programs included in the group viewing recommendations. For example, host application 220 may recommend a first program over an otherwise substantially similar second program where one or more of the mobile device user's has previously voted against the second program.

After all candidates have been voted upon, the operation 500 illustrated in FIG. 5 includes a determination (operation 544) by host application 220 of the election result. The election result, in some embodiments, may indicate whether there was a single winner or whether a runoff election involving two or more of the candidates is required. In some embodiments, the candidate receiving the highest percentage of favorable votes in a binary format or the recommended program receiving the highest indication of preference using any suitable scoring format, is automatically declared as the elected program and no runoff election is performed. In other embodiments, operation 500 may declare a runoff election when no program receives a sufficient percentage of the vote.

Referring to FIG. 9, an example of an election result interface 900 illustrated in FIG. 9 may be generated by host application 220 for an election that is held using a binary voting format that permits runoff elections. Election result interface 900 displays, in column 902, the percentage of votes each recommended program received. To determine whether any of the candidates received a vote that was sufficiently superior to the other candidates, the illustrated election result interface 900 displays, in column 904, the normalized vote received by each candidate. The normalized score may be determined by dividing the applicable percentage of favorable votes from column 902, by the sum of all percentage votes in column 902. The normalized percentage 904 shown in FIG. 9 reveals that all five titles received a normalized vote between 14 and 26%. Depending upon the runoff criteria employed, any two or more of the candidates may be selected. In one example, a candidate program is declared the elected winner only if it receives a normalized percentage exceeding 50%. When no program receives a normalized majority percentage, a runoff election may be held. In some embodiments, a runoff election may include a fixed number of candidates from the original election. For example, the top 2 candidates or top 3 candidates may proceed to a runoff when no candidate receives a majority of the normalized vote.

In other embodiments, the number of candidates in a runoff may be determined by a formula depending upon the election results. For example the first three candidates listed in election result interface 900 received normalized scores of 26, 22, and 21 respectively, resulting in cumulative normalized scores (column 906) of 26 for the candidate entitled Title 1, 48 for candidate Title 2, and 70 for the candidate Title 3. Because no candidate received a majority of the normalized vote, an election runoff may be held. In at least one embodiment, the number of runoff candidates is determined by the cumulative normalized score 906. For example, the number of runoff election candidates may equal the number of candidates required to achieve a cumulative normalized score of greater than 50.

For the results illustrated in FIG. 9, for example, Title 1, Title 2, and Title 3 would become the runoff candidates because the cumulative normalized score for Title 1 and Title 2 at 908 does not exceed 50. A runoff election may then be held involving the first three titles. Other embodiments, may employ different strategies for determining election runoffs and different scoring criteria. In the event of a runoff election, operations 540, 542, and 544 may be repeated for each runoff election until a program receives a vote sufficient to be declared the elected program, in which case, the operation 500 illustrated in FIG. 5 displays, at operation 546, an indication of the elected program.

Although FIG. 5 suggests the iterative operation of states 530, 540 and 542 until a winner is declared by the host application 220, other embodiments may of host application 220 and client application 250 may support a group termination feature in which one or more users specifies a winner from the presently recommended set of programs to force the completion of the election process. The termination feature may be employed beneficially when the group members reach a clear consensus with respect to the remaining recommended programs.

After an election is completed and an elected program has been determined, the illustrated embodiment of operation 500 includes tuning or acquiring (operation 550) the elected program. In the event that the elected program is a pre-recorded program provided by a content vendor or other service provider, the elected program may be downloaded or streamed over a suitable acquisition network. If the elected program is a live broadcast or other another program available from the service provider, application host may communicate with a set top box or smart television to tune to the elected program or record the elected program. Although not explicitly illustrated in FIG. 5, operation 550 may include playing the program on the display device 105.

Operation 550 may be omitted in dispersed location groups to identify content without acquiring or playing the content. In some embodiments, the group viewing recommendation resources are employed by a group to identify a program that might be viewed apart from any display screen associated with the host application. For example, a group who wishes to go to a movie theater and watch a movie may link to a group and vote for recommended programs until an elected program is determined or until the group reaches a consensus and voluntarily terminates the voting. For these embodiments, the host application does not need and may not have features for acquiring and playing back an elected program.

Operation 500 may include operations for gathering data summarizing the group viewing recommendation process associated with each group viewing recommendation instance. Operation 500 may include, as illustrated in FIG. 5 operation 560 in which the host application 220 obtains and records host experience data and operation 562 in which one or more the client applications 562 maintain client experience data. In at least one embodiment, host experience data may include information summarized by the host experience interface 1000 depicted in FIG. 10. As illustrated in FIG. 10, data that may be represented in host experience interface 1000 includes, as examples, the number of voters eligible to vote (1002), the percentage of eligible voters who linked to vote (1004), the duration of the linking window (1006), the percentage of linked voters that opted out of providing profile information (1008), the amount of time consumed retrieving profile data (1010), the amount of time consumed retrieving available programming information (1012), the amount of time required to identify the recommended programs (1014), and the number of rounds of the election (1016). Although FIG. 10 illustrates a specific set of parameters, other embodiments may employ more, fewer, or different parameters. The host experience interface 1000 displays the various parameters in two columns, column 1020 which displays the applicable value and column 1022 which indicates a percentile of the value indicated in column 1020 where the percentile may be determined based on a log of previous group viewing recommendation instances. The log of previous experience data may be local to the particular instance of host application 220. In other embodiments, the percentile data may be determined based on information aggregated over two or more instances of host application 220.

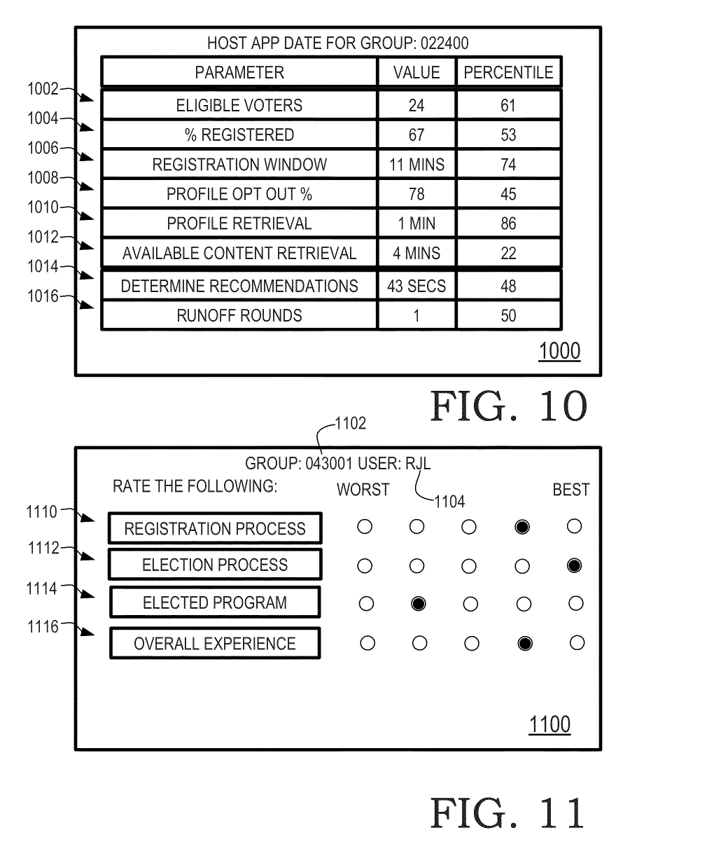

FIG. 11 illustrates a client experience interface 1100. The client experience interface 1100 illustrated in FIG. 11 summarizes feedback provided by one of the linked members. This information may be gathered from linked members after completion of an election, after an elected program has been viewed, or at another time convenient for the user. The client experience interface 1100 illustrated in FIG. 11 includes information reflecting the linked member's qualitative feedback of aspects of the group viewing recommendation process as a whole. For example, the client experience interface may obtain the linked member's “worst-to-best” scale evaluation of various aspects of the group viewing recommendation application. The illustrated client experience interface 1100 includes the linked member's assessment of the linking process, (1110), the election process (1112), the program that was ultimately elected (1114), and the linked member's overall experience (1116).

Client experience interface 1100 further includes information identifying the specific group (1002) and the linked member of the group (1104). The client experience data corresponding to client interface 1100 may be stored in the cloud or elsewhere and collected by a centralized server and evaluated to identifying patterns or correlations between the host experience data and the client experience data.

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A group viewing recommendation method, the method comprising:
generating a linking interface prompting a plurality of mobile device users to link to an indicated group;
responsive to receiving a wirelessly transmitted linking response from a client application on a mobile device users, linking the responding mobile device user as a group member of the indicated group;
responsive to at least one of the group members granting access to multimedia profile information, obtaining multimedia profile information associated with at least some of the group members, wherein multimedia profile information associated with a group member includes content preference information specified by the group member and viewing history information of the group member;
obtaining available program information indicative of available programs;
identifying a plurality of recommended programs based on the multimedia profile information and the available program information;
displaying on the display device the plurality of recommended programs for vote by the group members;
recording wirelessly transmitted votes cast by at least some of the linked members in the group; and
determining a result of the election based on the votes cast and displaying a result interface on the display device.

2. The method of claim 1, further comprising: linking code corresponding to the indicated group and displaying the linking code on a display device accessible to teach of the and wherein receiving the linking response comprises receiving a message from a mobile device user including an indication of the linking code.

3. The method of claim 2, wherein the response indicates:
whether the mobile device user grants access to multimedia profile information associated with the mobile device user; and
whether the mobile device user grants permission to record votes submitted by the mobile device user; and
wherein obtaining the multimedia profile information includes obtaining multimedia profile information from group members granting access to their multimedia profile information.

4. The method of claim 1, further comprising:
responsive to receiving a message indicating the linking code from a guest user invited to the group by the mobile device user, recognizing the guest user as a linked member of the group.

5. The method of claim 1, wherein the multimedia profile information includes external multimedia profile information provided by a content vendor with whom the mobile device user has an account.

6. The method of claim 1, wherein obtaining the available program information includes at least one of:
obtaining electronic programming guide information from a multimedia service provider; and
obtaining program catalogue listings of a content vendor.

7. The method of claim 1, wherein multimedia information on the client device includes information retrieved by the client device from a content vendor with whom the mobile device user has an account.

8. The method of claim 1, wherein displaying the plurality of recommended program comprises displaying a sequence of candidate program interfaces one at a time, each candidate program interface corresponding to one of the recommended programs.

9. The method of claim 8, wherein recording votes comprises recording either a favorable indication or an unfavorable indication for a candidate program.

10. The method of claim 8, wherein recording votes comprises recording an indication of favorability wherein the indication is selected from a group of more than two indications.

11. The method of claim 1, wherein determining the result of the election comprises determining an elected program comprising a candidate program receiving a vote tally satisfying an election criteria.

12. The method of claim 1, wherein determining the result comprising identifying runoff candidates according to a runoff criteria from the candidate programs and holding a runoff election.

13. The method of claim 1, further comprising:
recording host experience data summarizing characteristics of the group viewing recommendation method;
recording client experience data summarizing group member indications of favorability regarding aspects of the group viewing recommendation method; and
modifying the group viewing recommendation method based on a correlation between at least one element of the host experience data and at least one element of the client experience data.

14. A host device for providing group viewing recommendations, the host device comprising:
a processor;
a wireless transceiver;
a display adapter suitable for control a display device;
a memory device including processor-executable program instructions, the program instructions, when executed by the processor, causing the processor to perform operations comprising:
generating a linking interface for display on a display device, wherein the linking interface prompts mobile device users to link to an indicated group;
responsive to receiving wirelessly transmitted linking responses from responding mobile device users comprising at least some of the mobile device users, linking the responding mobile device users as group members of the indicated group;
responsive to at least one of the group members granting access to multimedia profile information, obtaining multimedia profile information associated with at least some of the group members, wherein multimedia profile information associated with a group member includes content preference information specified by the group member and viewing history information of the group member;
obtaining available program information indicative of available programs;
identifying a plurality of recommended programs based on the multimedia profile information and the available program information;
displaying on the display device the plurality of recommended programs for vote by the group members;
recording wirelessly transmitted votes cast by at least some of the linked members in the group; and
determining a result of the election based on the votes cast and displaying a result interface on the display device.

15. The host device of claim 14, wherein the host device comprises either a smart television or a set top box.

16. The host device of claim 14, wherein obtaining available programming information includes obtaining electronic programming guide information from a multimedia service provided communicatively coupled to the host device.

17. The host device of claim 14, wherein determining a result of the election includes determining a resulted selected from:
determining a winner and identifying an elected program as the winner; and
identifying runoff candidates based on runoff criteria and holding a runoff election.

18. A computer readable medium, including processor-executable program instructions that, when executed by a processor, cause the processor to perform operations comprising:
generating a linking interface, wherein the linking interface prompts mobile device users to link to an indicated group;
responsive to receiving wirelessly transmitted linking responses from responding mobile device users comprising at least some of the mobile device users, linking the responding mobile device users as group members of the indicated group;
responsive to at least one of the group members granting access to multimedia profile information, obtaining the multimedia profile information, wherein multimedia profile information associated with a group member includes content preference information specified by the group member and viewing history information of the group member;
obtaining available program information indicative of available programs;
identifying a plurality of recommended programs based on the multimedia profile information and the available program information;
displaying on the display device the plurality of recommended programs for vote by the group members;
recording wirelessly transmitted votes cast by at least some of the linked members in the group; and
determining a result of the election based on the votes cast and displaying a result interface on the display device.

19. The computer readable medium of claim 18, wherein the operations include:
displaying on the display device tallies of the votes cast.

20. The computer readable medium of claim 18, wherein the operations include:
displaying on the display device tallies of the votes cast.
